(19) United States
(12) Patent Application Publication
(10) Pub. No.: US 2023/0420780 A1
(43) Pub. Date: Dec. 28, 2023

(54) EXPANSION PANEL FOR BATTERY CELLS

(71) Applicant: Cummins Inc., Columbus, IN (US)

(72) Inventor: Jacob Ensign, Columbus, IN (US)

(21) Appl. No.: 18/210,361

(22) Filed: Jun. 15, 2023

Related U.S. Application Data
(60) Provisional application No. 63/354,767, filed on Jun. 23, 2022.

(51) Int. Cl. H01M 50/242; H01M 10/04; H01M 10/6556; H01M 10/658

(52) U.S. Cl. CPC H01M 50/242; H01M 10/0481; H01M 10/6556; H01M 10/658

(57) ABSTRACT

An expansion panel for installation against a battery cell in a battery assembly is disclosed. The expansion panel comprises two plates, wherein at least one plate is arranged to face the battery cell, and a spring layer between the two plates. The expansion panel may be able to provide pressure to the battery cell, while at the same time helping with cell cooling. The expansion panel may also provide a flame barrier, which may offer thermal runaway protection.

### CROSS REFERENCE TO RELATED APPLICATION

The present application claims the benefit of U.S. Provisional Application No. 63/354,767, filed Jun. 23, 2022, the disclosure of which is incorporated herein in its entirety for all purposes.

### FIELD OF THE DISCLOSURE

The present disclosure relates to an expansion panel for installation between battery cells. The present disclosure has particular, but not exclusive, application in battery packs for use in mobile applications such as electric or hybrid electric vehicles, construction equipment, and so forth.

### BACKGROUND

Electric vehicles and hybrid electric vehicles, such as cars, buses, vans and trucks, typically use battery packs that are designed with a high ampere-hour capacity in order to give power over sustained periods of time. A battery pack comprises a large number of individual electrochemical cells connected in series and parallel to achieve the total voltage and current requirements. To assist in manufacturing, assembly and servicing, the cells in a battery pack may be grouped into modules, or assembled directly to the battery pack.

In order to help with packing efficiency and reduce weight, some battery packs use pouch cells. Pouch cells provide energy dense electrical storage in the form of a relatively thin and generally flat pouch. Typically, a number of pouch cells are stacked together inside a support structure to form a battery module. The cells in the module are connected in series and parallel to achieve the target voltage.

In use, pouch cells may expand and contract. It is therefore known to provide an expansion pad (sometimes referred to as a compression pad) between adjacent pouch cells. The expansion pad is typically a layer of compressible foam. The expansion pad may apply pressure to the cells, which may help to extend the life of the cells. Expansion pads may also be necessary between other types of battery cell, such as prismatic cells.

Battery packs constructed from pouch cells and prismatic cells can provide energy dense electrical storage, making them suitable for use in mobile applications. However, a lack of air gaps between the cells can lead to the build-up of heat. Furthermore, if a cell is short-circuited or exposed to high temperature, exothermic reactions can be triggered, which may result in the cell overheating or catching fire. The close proximity of the individual cells means that if one cell catches fire, the fire can easily spread through the module. This may in turn lead to a thermal runaway event throughout the battery pack.

It would therefore be desirable to improve cell cooling as well as decrease flame propagation between cells in the event of thermal runaway, while maintaining a desired surface pressure on the cells.

### SUMMARY

According to one aspect of the present disclosure there is provided an expansion panel for installation against a battery cell in a battery assembly, the expansion panel comprising:
two plates, wherein at least one plate is arranged to face the battery cell; and
a spring layer between the two plates.

The present disclosure may provide the advantage that the expansion panel may be able to provide appropriate pressure to the cell, while at the same time helping with cell cooling. The expansion panel may also provide a flame barrier, which may offer thermal runaway protection.

The spring layer may be arranged to store elastic potential energy when the expansion panel is compressed. This may be achieved through deformation of the spring layer to create an opposing force. The force may be transferred to the battery cell through the plate. This may allow the expansion panel to apply pressure to the battery cell. Thus, the expansion panel may be arranged to apply a predetermined pressure to the battery cell.

The expansion panel may be arranged to accommodate expansion and contraction of a battery cell in use. This may be achieved through compression and expansion of the expansion panel. This may help to ensure correct functioning of the battery cell.

The pressure applied to the battery cell by the expansion panel may be, for example, between 0 and 10,000 kPa (0 to 100 bar) and may vary in dependence on the amount of expansion of the battery cell. For example, the expansion panel may be arranged to provide an initial pressure on the battery cell (when the cell has not expanded or contracted) of greater than 0, 25, 50 or 100 kPa (0, 0.25, 0.5, or 1 or bar) and/or less than 2000, 1500 or 1200 12 kPa (20, 15 or 12 bar). As the expansion panel compresses, it may increase the pressure applied to the battery cell. For example, the expansion panel may provide a maximum pressure of 3000, 6000 or 10,000 kPa (30, 60 or 100 bar) or more. However, it will be appreciated that all of these values are given by way of example only and may vary to suit the circumstances.

The spring layer may comprise a mechanical spring mechanism. For example, the spring layer may comprise one or more springs. This may help to ensure that a sufficient pressure can be applied to the battery cell.

The spring layer may be metallic. For example, the spring layer may comprise one or more springs made from a metal. This may help to ensure that a sufficiently high pressure can be applied to the battery cell and may facilitate heat transfer away from the cell and/or provide a flame barrier. The metal may be, for example, a ferrous metal, such as spring steel, or a non-ferrous metal, such as beryllium copper, titanium, or any other suitable metal or alloy. Alternatively, any other suitable material could be used for the spring layer. For example, the spring layer could be made from a plastic, such as a heat resistant or engineering plastic. This may be suitable in situations where a lower pressure needs to be applied to the battery cells. In this case, the expansion panel may be mainly utilized for cooling and/or flame propagation properties.

In one embodiment, the spring layer comprises at least one corrugated layer of spring (elastic) material. For example, the spring layer may comprise a corrugated sheet of spring steel, or any other suitable material (metallic or non-metallic). In this case, the corrugations may deform under pressure to create an opposing force, which is applied to the battery cell through a plate.

In another embodiment, the spring layer comprises an array of springs. The springs may be, for example, disc springs, leaf springs, coil springs, or any other suitable form of spring. The springs may be made from, for example, spring steel or any other suitable material (metallic or non-metallic).

The spring layer may be arranged to apply different pressures to different areas of a battery cell. For example, where the spring layer comprises an array of springs, the array of springs may comprise areas with different densities of spring and/or different types of spring. Where the spring layer comprises a corrugated layer of spring material, different areas may have a different density of corrugations. This may allow a higher pressure to be applied in those areas where it is needed most and/or may reduce structural demands placed on a support structure. For example, the spring layer may apply a higher pressure to an area at the center of the battery cell and a lower pressure towards the edges of the battery cell. If desired, three or more different pressure areas could be provided.

Each of the plates may comprise a sheet of material. For example, the plates may comprise a sheet of a metal, which may be a ferrous metal such as stainless steel, or a non-ferrous metal, or any other suitable material. The plates may be arranged to move and/or to flex to allow a force from the spring layer to be transferred to the battery cell.

In one embodiment, the expansion panel could be at least partially constructed of plastic. For example, one or both of the plates and/or the spring layer could be at least partially constructed from plastic (possibly with the inclusion, for example, or one or more metal layers or components). In one possible configuration, the expansion panel could be mainly or entirely constructed of plastic. An all-plastic configuration may at least partially forego some flame barrier properties and may work primarily as a consistent surface pressure element.

The two plates may each have a thickness of greater than 0.25 mm or 0.5 mm and/or less than 3 mm, 2 mm or 1.5 mm. For example, the two plates may each have a thickness of around 1 mm. The spring layer may have an initial thickness (when in use) of greater than 1 mm or 1.5 mm and/or less than 5 mm, 4 mm or 3 mm. For example, the spring layer may have an initial thickness of around 2 mm. The total thickness of the expansion panel may be, for example, greater than 1, 2 or 3 mm and/or less than 20, 10, 8 or 6 mm, although these values may be varied to suit the situation in which the panel is to be used. In use, the thickness of the expansion panel may vary (as the cells expand and contract) by between 10% and 50%, for example, around 25%, of its initial thickness. However, all of these values are given by way of example only, and other values may be used as appropriate.

The overall size and/or shape of the expansion panel may be chosen to match the size and/or shape of the battery cells with which it is to be used. For example, the expansion panel may be substantially rectangular and may have a width and/or height which is substantially the same as a battery cell with which the panel is to be used. Alternatively, two or more expansion panels could be arranged to face the battery cell. In this case, the two or more expansion panels may have either the same properties or different properties. For example, the two or more expansion panels could have different sizes and/or shapes, and/or could apply different pressures. The two or more expansion panels could be placed side by side, or face to face, or a combination of the two.

The expansion panel may have a hollow interior which accommodates the spring layer. For example, the two plates may be at least partially connected to enclose the spring layer. This may be achieved, for example, by connecting the two plates together at least part way around the perimeter of the two plates. In this case, at least one of the two plates may comprise a rim around its perimeter for connection to the other plate. The connection may be, for example, by brazing, welding, bonding, or any other type of connection. The expansion panel may also comprise at least one side wall in order to space the two plates apart sufficiently to accommodate the spring layer. For example, at least one plate may comprise a side wall, for example between the rim and a face of the plate.

The spring layer may comprise channels which allow the flow of coolant through an interior of the expansion panel. This may allow active cooling of the battery cells, which may help with thermal management of the battery assembly. The expansion panel may comprise at least one port arranged to supply coolant to an interior of the expansion panel. Alternatively, at least one side (for example, two opposing sides) of the expansion panel may be open, to allow the flow of coolant through the interior. The coolant may be any suitable coolant, for example, a gas or a liquid coolant such as air, oil, water, a water/glycol mix or a specialist battery coolant such as a dielectric fluid.

In one embodiment, the expansion panel comprises two opposing sides each with a sidewall, and two opposing sides which are open. In the case where the spring layer is corrugated or otherwise unidirectional, the corrugations may run parallel to the sidewalls. This may allow coolant to flow through the expansion panel between the corrugations.

In another embodiment, instead of or as well as a mechanical spring mechanism, the spring layer may comprise a fluid. In this case, compression of the fluid may create an opposing force which applies pressure to the battery cells. For example, the expansion panel may be completely sealed, and the fluid may act at the spring layer. Alternatively, fluid may be pumped under pressure into the interior of the expansion panel.

The expansion panel may be arranged to provide a flame barrier between the battery cells. This may be achieved, for example, by constructing the expansion panel at least partially from a metallic material such as a ferrous metal, or other non-flammable material, rather than foam or rubber.

The expansion panel may be arranged to be installed between two adjacent battery cells. In this case, each plate may be arranged to face a respective battery cell. For example, a battery assembly comprising a stack of battery cells may have an expansion panel between each pair of adjacent cells. An expansion panel may also be provided at one or both ends of the stack of cells.

According to another aspect of the disclosure there is provided a battery assembly comprising a plurality of battery cells and at least one expansion panel between two adjacent battery cells, the expansion panel comprising:
two plates, each plate arranged to face a respective battery cell; and
a spring layer between the two plates.

The battery assembly may be, for example, a battery module or a battery pack. For example, the battery assembly may be a battery module comprising a plurality of battery cells for use in a battery pack. Alternatively, the battery cells may be provided in a battery pack without being divided into modules (cell to pack system). The battery cells may be, for example, pouch cells, prismatic cells, or any other suitable type of cell.

The battery cells may use any suitable type of battery chemistry. For example, the battery cells could be Lithium Ion, Lithium Metal, Lithium Phosphate, Nickel Metal Hydride, NMC or Lithium Cobalt battery cells or any other type of battery cell. The expansion panel may advantageously be used in situations where a relatively high pressure needs to be applied to the battery cells, which may be the case for example with Lithium Metal cells. However, the expansion panel is not limited to such use and may be used with any suitable type of battery cell using any suitable chemistry.

The plurality of battery cells may be stacked together, and an expansion panel may be provided between two adjacent battery cells. Thus, the battery assembly may comprise a plurality of expansion panels interleaved between the battery cells. An expansion panel may also be provided at one or both ends of the stack of battery cells.

The expansion panel may apply a predetermined pressure to the battery cells. For example, the battery assembly may comprise a support structure (such as a housing), and the support structure may be arranged to contain the battery cells and to ensure that a required pressure is maintained against the cells.

The expansion panel may have a hollow interior. In this case, the battery assembly may be arranged such that coolant is supplied to the interior of the expansion panel. For example, the battery assembly may comprise at least one supply line arranged to supply coolant to an interior of the expansion panel.

In one embodiment, the battery cells and the at least one expansion panel may be immersed in coolant. For example, the battery assembly (such as a battery module or a battery pack) may comprise a sealed housing, and the battery cells, the at least one expansion panel and the coolant may be contained in the housing. The housing may comprise at least one inlet port and at least one outlet port to allow coolant to flow into and out of the housing. The at least one expansion panel may be open on opposing sides to allow coolant to flow through the expansion panel. The coolant in this embodiment may be any appropriate electrically non-conductive liquid, such as a dielectric fluid.

According to another aspect of the disclosure there is provided a battery system comprising a battery assembly in any of the forms described above and a cooling unit for circulating coolant through the battery assembly. The cooling unit may comprise at least one of a pump, a radiator, a fan, a temperature sensor and a cooling controller.

Corresponding methods may also be provided. Thus, according to another aspect of the disclosure there is provided a method of assembling a battery assembly, the battery assembly comprising a plurality of battery cells and at least one expansion panel, the expansion panel comprising two plates and a spring layer between the two plates, the method comprising stacking the battery cells with an expansion panel between two adjacent battery cells, compressing the stack of battery cells to thereby compress the spring layer, and retaining the compressed stack of cells with a support structure.

The method may further comprise circulating a coolant through the expansion panel. The coolant may be any suitable coolant, for example, a gas or a liquid coolant such as air, oil, water, a water/glycol mix or a specialist battery coolant such as a dielectric fluid (for example, synthetic dielectric esters) or any other suitable coolant.

Features of one aspect of the disclosure may be provided with any other aspect. Apparatus features may be provided with method aspects and vice versa.

### BRIEF DESCRIPTION OF THE DRAWINGS

Preferred embodiments of the present disclosure will now be described, purely by way of example, with reference to the accompanying drawings, in which:

FIG. 1 shows parts of a known battery module;

FIG. 2 shows principal parts of an expansion panel in an embodiment of the disclosure;

FIG. 3 shows parts of an expansion panel in one embodiment of the disclosure;

FIG. 4 shows parts of a battery module in an embodiment of the disclosure;

FIG. 5 shows parts of a battery system in an embodiment of the disclosure;

FIG. 6 shows part of an expansion panel in another embodiment of the disclosure;

FIG. 7 shows part of an expansion panel in a further embodiment of the disclosure;

FIG. 8 shows parts of a battery module in another embodiment of the disclosure;

FIG. 9 illustrates coolant flow through a battery module;

FIG. 10 illustrates coolant flow through an expansion panel; and

FIG. 11 shows parts of a battery system in another embodiment of the disclosure.

### DETAILED DESCRIPTION OF EMBODIMENTS OF THE DISCLOSURE

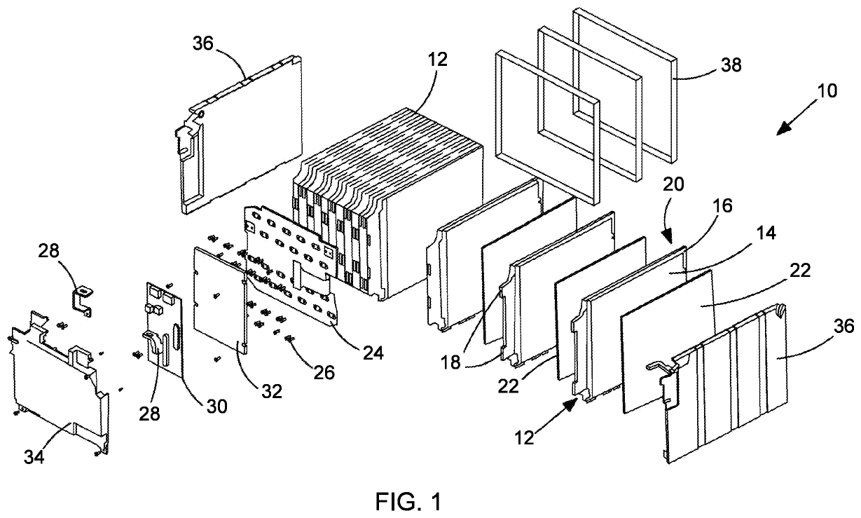

FIG. 1 shows parts of a known battery module. The battery module is designed for use in a battery pack containing a plurality of battery modules. The battery module and/or battery pack may be, for example, as described in UK patent application number GB 2594916, the subject matter of which is incorporated herein by reference.

Referring to FIG. 1, the battery module 10 is formed from a stack of battery cells 12. Each battery cell 12 is in the form of a pouch cell 14 held within a cell tray 16. The cell tray 16 includes electrical terminal blocks 18, which are used to make electrical connections to the pouch cell 14. Each battery cell 12 also has a cooling sheet 20 which is used to conduct heat away from the pouch cell 14. The cooling sheets 20 are made from a thermally conductive material such as aluminium or graphite. A compression foam expansion pad 22 is provided between adjacent cells 12.

In FIG. 1, a laminated busbar 24 is used to electrically connect the various battery cells 12. The laminated busbar 24 is connected to the cells 12 by means of electrically conducting pins 26. The laminated busbar 24 includes electrical conductors which connect the battery cells 12 in the required series and/or parallel connections to achieve the target voltage. The laminated busbar 24 also connects to positive and negative terminals 28 which provide electrical connections to and from the battery module 10.

Also shown in FIG. 1 is a battery management unit 30. The battery management unit 30 is used to monitor and manage cell charge and other aspects of cell operation. The battery management unit 30 is provided on a circuit board, which is mounted on the laminated busbar 24 via an electrically insulating barrier plate 32. The battery management unit 30 is protected by removable cover 34.

In order to assemble the battery module 10, the various battery cells 12 (comprising pouch cell 14, cell tray 16, terminal blocks 18 and cooling plate 20) are stacked together with a foam expansion pad 22 between each adjacent battery cell. End plates 36 are then added to each side of the stack of battery cells. The stack of battery cells is then compressed to the required pressure. This ensures that the foam expansion pads 22 provide the required pressure to each of the pouch cells 14. Steel bands 38 are placed around the stack of cells as it is held under pressure. The ends of the steel bands are then crimped together. Thus, the steel bands ensure that the required pressure is maintained against the cells in the module, as well as maintaining the size and shape of the battery module.

It will be appreciated that the battery module described above is given by way of example only, and other types of battery module and battery pack may be used instead. For example, rather than using steel bands, the battery module could be contained within a rigid housing which applies the require pressure to the battery cells. Rather than pouch cells, prismatic cells or other types of cell could be used instead. If desired, the battery cells could be stacked inside a battery pack without being separated into battery modules (cell-to-pack design).

In use, the cells within a battery pack tend to expand and contract. In the arrangement described above, expansions pads are used to accommodate cell expansion. The expansion pads provide pressure on the cell surfaces as they undergo charge/discharge cycles. The expansion pads are typically formed from a foam or rubber material, such as a polyurethane foam. However, such expansion pads offer no or limited cooling between the cells and no or limited flame barrier. Furthermore, some types of battery cell may require a high or varied pressure, which may be difficult to achieve with foam expansion pads. For example, rechargeable (secondary) lithium metal battery cells are being developed which may require a relatively high and consistent pressure to be maintained on the cell.

Embodiments of the present disclosure provide an alternative solution which can provide a high-pressure face mechanism that can also act as a flame barrier between cells and give the ability to actively heat or cool the cells.

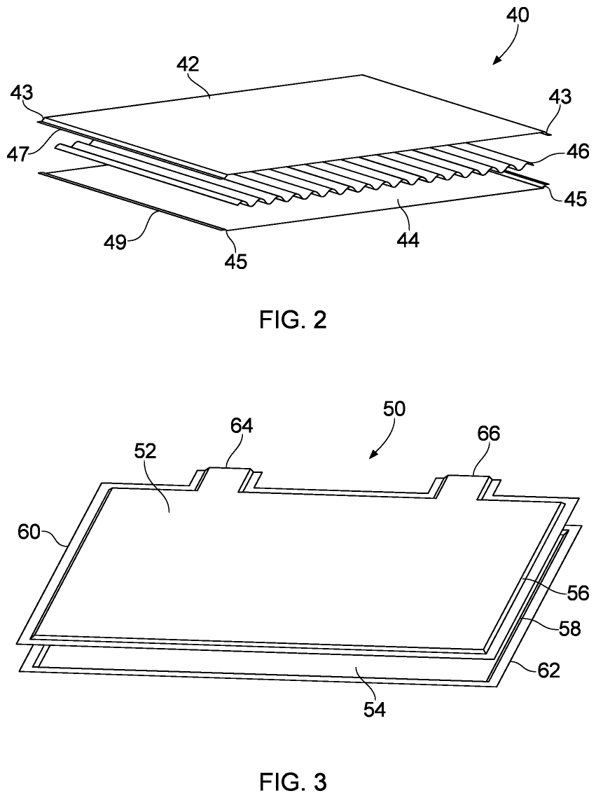

FIG. 2 shows an expansion panel in an embodiment of the disclosure. Referring to FIG. 2, the expansion panel 40 comprises two plates 42, 44 that are separated by a spring layer 46. The two plates 42, 44 are made from a sheet of metal such as stainless steel. The spring layer 46 is in the form of a corrugated sheet of elastic material such as spring steel. The spring layer 46 stores elastic potential energy when it is compressed. The spring layer 46 can “float” (be unattached to the plates) or may be bonded or otherwise attached to the plates 42, 44 to form one assembly.

Each of the two plates 42, 44 is substantially rectangular in shape. Each plate 42, 44 has two opposing edges which bend inwards to form sidewalls 43, 45. The sidewalls 43, 45 are bent outwards at their extremity to form rims 47, 49. In the assembled expansion panel, the rims 47, 49 of each plate 42, 44 are connected together. The rims 47, 49 may be connected, for example, by brazing, welding, bonding or in any other way. Alternatively, the plates 42, 44 could float or have locating features, and the expansion panel could be held together, for example, by the module housing. When the rims 47, 49 are connected, the two plates 42, 44 form a housing which accommodates the spring layer 46 and holds the expansion panel together. The other two edges of the plates 42, 44 are not bent inwards (or are only partially bent inwards) and are not connected together. Thus, the expansion panel has a sidewall along two opposing sides, and is open along the other two opposing sides. In this embodiment, the corrugations in the spring layer 46 run in the same direction as the sidewalls 43, 45. This can allow a cooling fluid such as air or a liquid coolant to enter the expansion panel through one open side, flow through the spring layer 46 between the corrugations, and then exit the expansion panel through the other open side. Alternatively, the corrugations could run at another angle (for example 45° or some other angle) to the sidewalls, which may help with heat transfer.

It will be appreciated that, while in FIG. 2 the expansion panel has sidewalls which are formed by bending the edges of the two plates inwards, the sidewalls could be formed in any other way. For example, the sidewalls could be formed by bending the edges of just one of the plates, or separate sidewalls could be attached to the two plates. Alternatively, the two plates could be formed from a single piece of material bent into the appropriate shape and connected at its extremities.

In use, the expansion panel 40 is installed between two adjacent battery cells, either pouch cells, or prismatic cells, or any other appropriate cell type. The cells are contained within a support structure which can maintain a pressure against the cells. When installed, the expansion panel 40 applies a predetermined pressure on the faces of the cells. The pressure is formed by deformation of the spring layer 46 to create an opposing force. In addition, the two plates 42, 44 have sufficient flexibility to deflect slightly, allowing the pressure from the spring layer 46 to be transferred to the cells. As further pressure is applied to the outside faces, the spring layer 46 compresses further, allowing expansion of the cells, while also maintaining surface pressure.

The expansion panel 40 is manufactured from a non-flammable material, such as a metal, rather than foam or rubber. For example, the two plates 42, 44 may be manufactured from a ferrous alloy such as stainless steel, or another appropriate metal. The spring layer may be a corrugated sheet of metal such as spring steel. This provides the advantage that the panel is not flammable. Therefore, the panel provides a flame barrier between cells, rather than being a propagator of flame.

The properties of the spring layer, such as the type of material, the thickness of the material, the thickness of the layer, the number of corrugations and so forth are chosen to achieve the desired pressure and amount of expansion. For example, the expansion panel may be arranged to provide an initial pressure on the battery cells of between 1 and 12 bar (100-1200 kPa). The expansion panel may be arranged to compress in use by approximately 25%. As the expansion panel compresses, it may increase the pressure applied to the battery cells. For example, the expansion panel may provide a maximum pressure of 30 bar or more (for example 60 bar). However, it will be appreciated that all of these values are given by way of example only and may vary to suit the circumstances.

The width and height of the expansion panel 40 can be chosen to match the size of the battery cells with which it is to be used. For example, some typical sizes of battery cells are 300 mm×200 mm and 85×95 mm, although it will be appreciated that many other different sizes are also available, and the size of the expansion panel may be adjusted accordingly. The shape of the expansion panel may be chosen to match the profile of the battery cells with which it is to be used. For example, the expansion panel may be substantially rectangular, or any other appropriate shape. If desired, two or more expansion panels could be used between two adjacent cells, in which case the size and/or shape of the expansion panels could be adjusted accordingly.

The thickness of the expansion panel (corresponding to the gap between two adjacent battery cells) is chosen, on one hand to ensure that sufficient pressure is applied to the cells, and on the other hand to minimize gaps between the cells and thus maximise the energy density of the battery assembly. For example, in one possible arrangement, the expansion panel may have a thickness of around 3-4 mm in its initial state. The spring layer 46 may have an initial thickness of around 2 mm and may compress to a thickness of around 1 mm as the cells expand. The two plates may each have a thickness of around 1 mm. It will be appreciated that these values are given by way of example only, and other values may be used as appropriate.

The expansion panel 40 is thermally conductive, and thus is able to conduct heat away from the battery cells. For example, the expansion pad may conduct heat to a cooling plate located adjacent to the battery cells. Such a cooling plate is disclosed in UK patent application number GB 2594916, the subject matter of which is incorporated herein by reference, although any other type of cooling plate could be used instead.

If desired, additional layers could be provided on the plates 42, 44 and/or the spring layer 46. For example, a thermally conductive, electrically insulative film may be provided on the plates 42, 44.

In one embodiment, the expansion panel 40 is hollow and is manufactured in such a way that a recirculating cooling fluid can flow through the inside of the panel. This gives the ability to actively cool or heat the faces of the cells, which increases the thermal stability of the battery assembly.

FIG. 3 shows parts of an expansion panel in one embodiment. Referring to FIG. 3, the expansion panel 50 comprises two plates 52, 54 separated by a spring layer, in a similar way to the arrangement of FIG. 2. In FIG. 3, the edges of the plates 52, 54 are bent inwards to form sidewalls 56, 58. The side walls 56, 58 are then bent outwards to form rims 60, 62. This gives each of the plates 52, 54 a clamshell shape. The rims 60, 62 of the two plates are connected together so that the two plates form a sealed housing which accommodates the spring layer.

In the arrangement of FIG. 3, two ports 64, 66 are provided on one side of the expansion panel 50. The ports 64, 66 are formed by extending part of the plates 52, 54, together with the walls 56, 58 and rims 60, 62, outwards from the body of the plates 52, 54. The ports 64, 66 allow coolant to flow into and out of the interior of the expansion panel. The coolant flows in gaps between the two plates 52, 54 created by the spring layer. Where the spring layer is in the form of a corrugated sheet of material, the coolant flows in the channels created by the corrugations. In addition, gaps may be left between the spring layer and the two plates in some places and/or holes made in the spring layer, in order to ensure that the coolant can circulate through the whole of the expansion panel.

In the arrangement shown, the ports 64, 66 are provided on the top side of the expansion panel 50. However, they could be provided on any side and be oriented any direction. Furthermore, the two ports are need not be on the same side of the expansion panel, and they could be for example on opposite sides.

The two plates 52, 54 may be manufactured by stamping from an appropriate sheet of material such as stainless steel. The spring layer may be manufactured from an appropriate elastic material such as heat-treated spring steel. The rims 60, 62 of the two plates 52, 54 may be connected together, for example, by brazing, welding, bonding, or in any other way. For example, the two plates may be connected together using furnace brazing. However, other materials and manufacturing techniques may be used instead. The ports 64, 66 may be provided with seals such as O-rings, or any other appropriate connector which can provide a sealed connection with a fluid conduit.

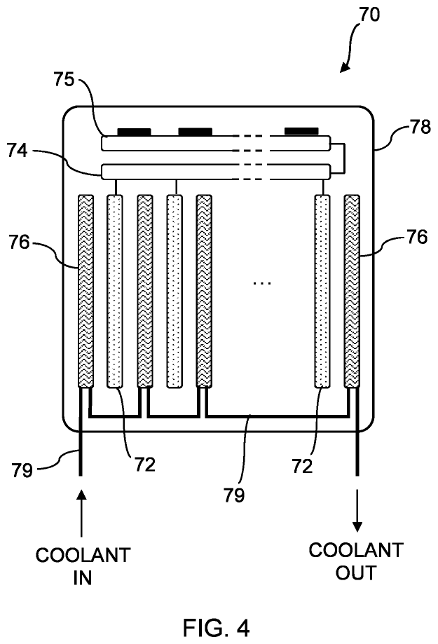

FIG. 4 shows parts of a battery module in an embodiment of the disclosure. Referring to FIG. 4, the battery module 70 comprises a plurality of battery cells 72, a busbar 74 and a battery management unit 75. In this embodiment, the battery cells 72 are pouch cells or prismatic cells stacked together side-by-side. The busbar 74 is used to connect the battery cells 72 in the required series/parallel configuration. The busbar 74 includes voltage sensors which monitor the voltages of individual battery cells, or groups of battery cells connected in parallel. A current sensor senses total current through the module. In addition, one or more temperature and/or pressure sensors are used to sense the temperature and/or pressure of the module. The busbar 74 is connected to the battery management unit 75. The battery management unit 75 receives the sensed voltages, current and temperature. The sensed voltages, current and temperature are used to monitor and manage cell charge and discharge.

In the arrangement of FIG. 4, an expansion panel 76 is provided between each adjacent battery cell 72, and at each end of the battery module. Each expansion panel 76 comprises two plates separated by a spring layer, in the manner described above. In FIG. 4, the battery cells 72 and the expansion panels are shown spaced apart for ease of reference, but in practice they will be stacked together. The expansion panels 76 apply a predetermined pressure to the battery cells 72, as well as allowing for some expansion and contraction of the cells. The stack of expansion panels and battery cells are contained within a rigid housing 78 which allows the pressure on the cells to be maintained. Alternatively, or in addition, the module could be held together using steel bands in the manner described above with reference to FIG. 1.

In FIG. 4, each expansion panel 76 includes an inlet port and an outlet port which allow coolant to flow into and out of the interior of the expansion panel. The input ports and output ports are connected to coolant supply lines 79. The coolant supply lines 79 carry coolant to and from the expansion panels 76. The coolant may be any suitable liquid coolant, such as oil, a water/glycol mix or a specialized battery coolant such as a dielectric fluid.

In operation, coolant enters the module 70 through a supply line 79 and flows into a first expansion panel 76 through an inlet port. The coolant flows through the interior of the expansion panel, between the two plates and through the spring layer. The coolant exits the first expansion panel through its outlet port. The coolant then flows through a supply line to the inlet port of a second expansion panel. Successive expansion panels are connected together by the coolant supply lines, such that the coolant flows through all of the expansion panels before finally exiting the battery module. In this way, coolant is circulated through all of the expansion panels 76 in the battery module 70. This actively cools (or heats) the faces of the cells, which greatly increases the thermal stability of the battery module.

Although in FIG. 4 the coolant circuit connects the expansion panels in series, it would also be possible for the expansion panels to be connected in parallel, for example using a common rail to supply coolant to each of the expansion panels, or a combination of the two.

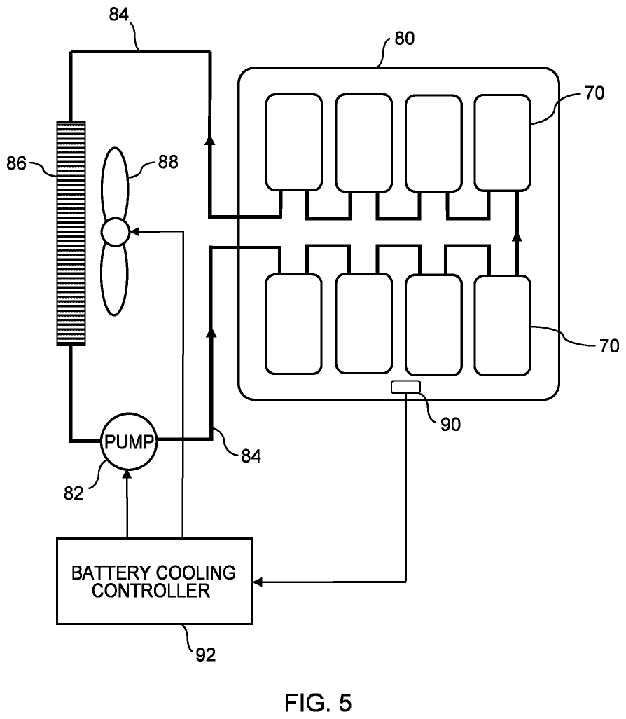

FIG. 5 shows parts of a battery system in an embodiment of the disclosure. Referring to FIG. 5, the battery system comprises a battery pack 80 comprising a plurality of battery modules 70, a pump 82, tubing 84, a radiator 86, a fan 88, a temperature sensor 90 and battery cooling controller 92. The battery modules 70 in the battery pack are connected in series using appropriate fluid conduits such as tubing. In operation, the pump 82 is used to pump coolant through the tubing 84 to the battery modules 70. The coolant flows through the expansion panels in the battery modules 70 in order to conduct heat away from the battery cells, in the manner described above. The coolant circuit may connect the battery modules 70 in series, as shown in FIG. 5, or in parallel, or a combination thereof. Coolant exiting the battery pack 80 flows to the radiator 86. The fan 88 blows cooling air through the radiator to reduce the temperature of the coolant before it returns to the pump 82. If desired, a coolant reservoir (not shown) could be provided between the radiator 86 and the pump 82. The speeds of the pump 82 and the fan 88 are controlled by the battery cooling controller 92. The temperature sensor 90 senses the temperature of the battery pack and feeds the sensed temperature to the battery cooling controller 92. The battery cooling controller 92 receives the sensed temperature and adjusts the speeds of the pump 82 and the fan 88 to achieve the desired temperature. If desired, individual temperatures from inside the battery modules 70 could also be sensed and fed to the battery cooling controller 92 for use in control of the battery temperature.

Although not shown in FIG. 5, a heater could also be provided to heat the coolant before it flows to the battery pack. This can allow the cells in the battery pack to be heated to a desired operating temperature, for example, when the battery pack is first used and/or where the environmental temperature is low.

In the arrangements described above, the expansion panel is installed between battery cells and applies a predetermined pressure to the face of the cells. By using a metallic spring layer, a greater pressure may be applied than would be achievable with foam. The expansion panel also allows for some expansion and contraction of the cells in operation. The expansion panel is hollow, and allows a recirculating cooling fluid to pass continuously through the battery module. This gives the ability to actively cool (or heat) the faces of the cells, while also maintaining the desired face pressure. Further, since the expansion panel is not made from foam or rubber, it is not flammable, and therefore presents a flame barrier between cells. This may help to prevent or slow down thermal runaway.

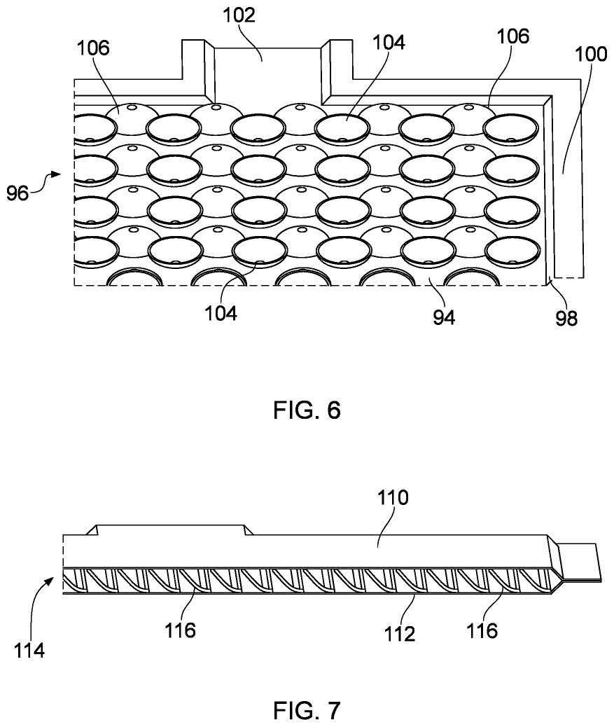

FIG. 6 shows part of an expansion panel in another embodiment of the disclosure. In this embodiment, the expansion panel comprises two clamshell shaped plates separated by a spring layer, in a similar way to the arrangement of FIG. 3. However, in the arrangement of FIG. 6, an array of disc springs (sometimes referred to as Belleville springs, conical springs or cupped springs) is used as the internal spring mechanism.

Referring to FIG. 6, the expansion panel comprises a bottom plate 94 and a spring layer 96. In the assembled expansion panel, a top plate is also provided, although this is not shown in FIG. 6 for clarity. The bottom plate 94 comprises sidewalls 98 and a rim 100. Part of the plate 94 extends outwards to form a port 102. The rim 100 on the bottom plate 94 is arranged to be connected to a corresponding rim on the top plate in a similar way to that described above with reference to FIG. 3.

In the arrangement of FIG. 6, the spring layer comprises an array of disc springs 104, 106. The disc springs are in the form of conical shells which can be loaded along their axes. The disc springs may be made from any suitable elastic material such as spring steel. Some of the disc springs 104 face in one direction, with their apex against the bottom plate 94 and their base against the top plate. The other disc springs 106 face in the opposite direction, with their apex against the top plate and their base against the bottom plate 94. Each disc spring 104, 106 is attached to a respective plate at its apex, for example, by brazing, welding, bonding or in any other way. The disc springs 104, 106 are placed close enough to each other to create an even pressure on the outside surface of the expansion panel when they are compressed. Gaps between the springs 104, 106 can allow coolant to flow through the expansion panel.

In use, the expansion panel is installed between two adjacent battery cells in a similar way to that described above. When installed, the expansion panel applies a predetermined pressure on the faces of the cells. The pressure is formed by deformation of the disc springs 104, 106 to create an opposing force. As further pressure is applied to the outside faces, the disc springs 104, 106 compress further, allowing expansion of the cells, while also maintaining surface pressure. If desired, a coolant may be circulated through the interior of the expansion panel, through the gaps between the disc springs 104, 106.

The arrangement of FIG. 6 can allow different pressure zones to be provided across the surface of the battery cell. For example, a different density of disc spring and/or different size of disc spring in different areas can allow higher and lower pressure areas to be designed into a single unit. This can allow a higher pressure to be focused on those areas where it is needed most, such as towards the centre of the battery cells, while helping to minimize the demands placed on the support structure.

FIG. 7 shows part of an expansion panel in a further embodiment of the disclosure. Referring to FIG. 7, the expansion panel comprises a top plate 110, a bottom plate 112 and a spring layer 114. The top plate 110 and bottom plate 112 may be the same as or similar to those described above with reference to FIGS. 2, 3 and 6. However, in FIG. 7, the spring layer 114 uses uni-directional leaf springs 116 to generate the internal resistance force. These internal leaf springs 116 can also be oriented in multiple directions, and with variable density, to create higher and lower pressure regions within the unit. Coolant may flow through gaps between the springs.

If desired, other types of spring could be used in the spring layer. For example, coil springs, hair springs, serpentine springs, garter springs, volute springs, V-springs, wave springs or any other type of spring could be used. If desired, different types of spring could be used in the same expansion panel, for example, to create different pressure zones or different amounts of travel.

Embodiments of the disclosure thus provide an expansion panel comprising two plates separated by a spring mechanism. This allows surface pressure to be maintained on cells, while simultaneously providing a method of cooling the full face of the cell. The orientation of the spring mechanism can allow a cooling fluid, such as air or a liquid coolant, to be forced through the assembly. This can allow a consistent surface pressure to be applied to the face of a battery cell, which may be necessary for some forms of battery cells, while a cooling fluid flowing through the spring mechanism can provide full surface cooling for the cells.

In further embodiments of the disclosure, the battery cells and the expansion panels are provided inside a sealed housing, and the cells and the expansion panels are immersed in a liquid coolant.

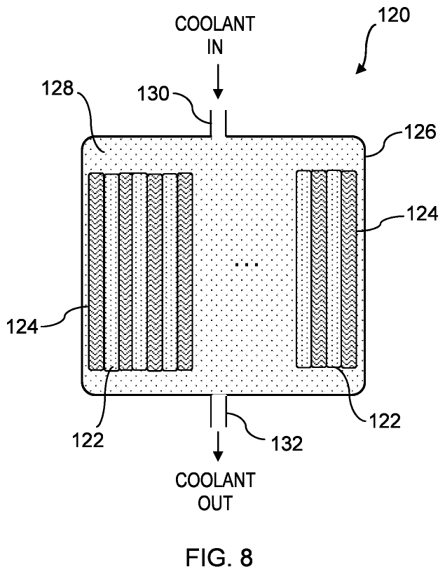

FIG. 8 shows parts of a battery module in another embodiment of the disclosure. Referring to FIG. 8, the battery module 120 comprises a plurality of battery cells 122 and a plurality of expansion panels 124 housed within a housing 126. The battery cells 122 are pouch cells or prismatic cells stacked together side-by-side. Although not shown in FIG. 8, a busbar may be used to connect the battery cells in a similar way to the previous embodiments, or the cells may be directly connected together for example by welding. The busbar may be provided either inside the housing 126 or outside the housing. The busbar may be connected to a battery management unit, which may be inside or outside the housing 126. The expansion panels 124 are interleaved with the battery cells. Each expansion panel 124 comprises two plates separated by a spring layer, in the manner described above. The expansion panels 124 apply a predetermined pressure to the battery cells 122, as well as allowing for some expansion and contraction of the cells. The housing 126 has sufficient rigidity to allow the pressure on the cells to be maintained. Alternatively, or in addition, retaining bands could be provided around the housing to help maintain the pressure, or any another means of applying pressure could be used.

In the arrangement of FIG. 8, the housing 126 is a sealed housing which contains a liquid coolant 128. The housing 126 comprises an input port 130 and an outlet port 132 which allow the coolant to flow into and out of the housing. The coolant in this embodiment may be any appropriate electrically non-conductive liquid with the desired thermal transfer properties. Suitable coolants include commercially available dielectric fluids such as synthetic dielectric esters, although any other suitable electrically non-conductive coolant could be used instead.

In operation, coolant enters the module 120 through the input port 130. The coolant 128 flows through the interior of the housing 126 and out of the module through the output port 132. The principal path for the flow of the coolant 128 is through the expansion panels 124. The expansion panels 124 (and the spring layers within the expansion panels) are orientated such that the coolant can enter on the side of the input port 130 and exit on the side of the output port 132. Thus, the coolant flows through the interior of each expansion panel, between the two plates and through the spring layer. This actively cools (or heats) the faces of the cells.

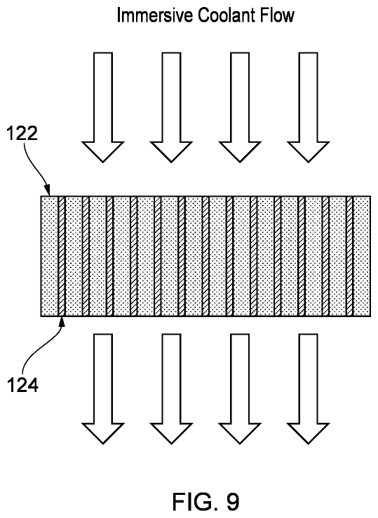

FIG. 9 illustrates coolant flow through the battery module. The battery module comprises a stack of battery cells 122 interleaved with expansion panels 124. In FIG. 9, the battery cells and the expansion panels are viewed from the side. The battery cells 122 and expansion panels 124 are immersed in coolant. The expansion panels are open on two opposing sides (the top and bottom sides in FIG. 9). The coolant flows through the interior of each expansion panel 124, between the two plates and through the spring layer as illustrated by the arrows. This actively cools (or heats) the faces of the battery cells 122.

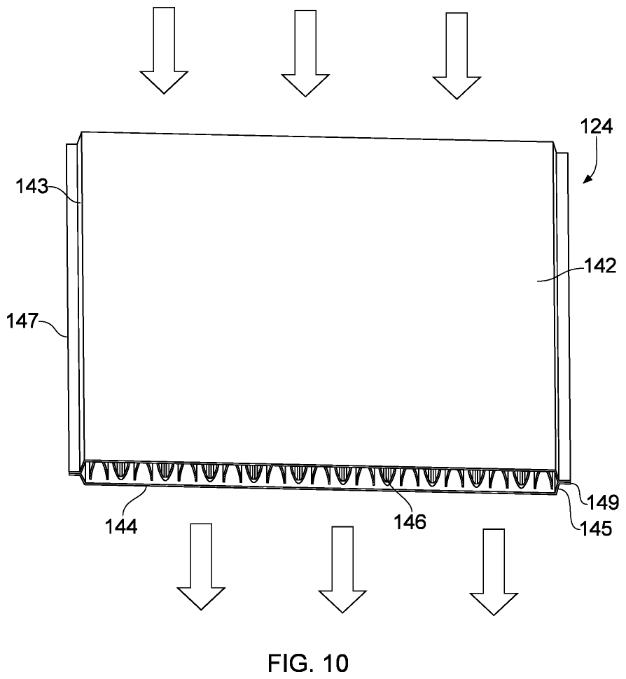

FIG. 10 illustrates coolant flow through one of the expansion panels. In FIG. 10, the expansion panel is viewed from the front. The expansion panel 124 comprises two plates 142, 144 separated by a spring layer 146. In this embodiment the spring layer 146 is in the form of a plurality of elongated springs with a U-shaped cross-section, although it could take any other form such as a corrugated sheet of elastic material, such as spring steel, or any of the other types of spring layer described above. Each plate 142, 144 has two opposing edges which bend inwards to form sidewalls 143, 145. The sidewalls 143, 145 run in the same direction as the corrugations in the spring layer 146. The sidewalls 143, 145 are bent outwards at their extremity to form rims 147, 149. The rims 147, 149 of each plate 142, 144 are joined together so that the two plates form a housing which accommodates the spring layer 146. The other two edges of the plates 142, 144 are not bent inwards and are not connected together. Thus, the expansion panel is sealed along two opposing sides, and open along the other two opposing sides. This can allow a cooling fluid such as air or a liquid coolant to flow through the spring layer 146 between the corrugations as illustrated by the arrows in FIG. 10.

The expansion panel may be for example in the form described above with reference to FIG. 2. Alternatively, other forms of spring layer, such as those illustrated in FIG. 6 or 7, could be used instead or as well.

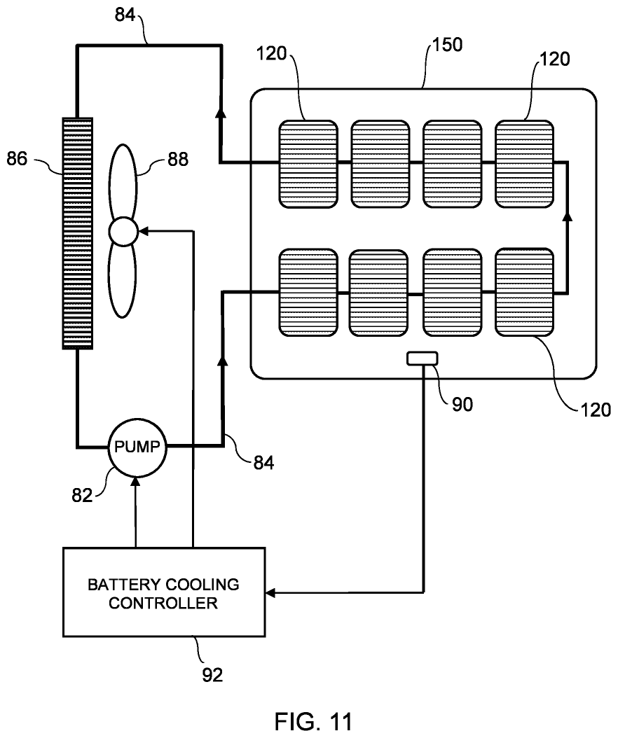

FIG. 11 shows parts of a battery system in another embodiment of the disclosure. Referring to FIG. 11, the battery system comprises a battery pack 150 comprising a plurality of battery modules 120, a pump 82, tubing 84, a radiator 86, a fan 88, a temperature sensor 90 and battery cooling controller 92. The pump 82, tubing 84, radiator 86, fan 88, temperature sensor 90 and battery cooling controller 92 may be substantially as described above with reference to FIG. 5.

In the arrangement of FIG. 11, each of the battery modules 120 comprises a stack of battery cells interleaved with expansion panels. The battery cells and expansion panels are immersed in coolant and contained within a sealed housing with an input port and an output port. An output port of one battery module 120 is connected to the input port of a subsequent battery module using an appropriate fluid conduit such as tubing. The battery modules 120 are thus connected in series, such that the coolant can flow through successive modules. The expansion panels in the battery modules are orientated such that the coolant can flow through them between the input port and the output port of the module within which they are housed. The output of the pump 82 is connected to the input port of the first battery module in the series connection of battery modules. The output port of the last battery module is connected to the radiator 86.

In operation, the pump 82 is used to pump coolant through the tubing 84 to the battery modules 120. The coolant flows through the expansion panels in the battery modules 120 in order to conduct heat away from the battery cells. While a series arrangement is shown in FIG. 11, it would also be possible for the battery modules to be connected in parallel or in a combination of series and parallel.

In an alternative embodiment, the battery pack 150 forms a sealed housing which contains a liquid coolant, and the battery cells and expansion panels are immersed in the coolant. The battery cells may be divided into modules, or they may be mounted directly to the battery pack without being divided into modules (cell to pack design). In this embodiment, the battery pack housing is provided with input and output ports which allow the coolant to flow into and out of the battery pack.

In any of the above embodiments, the expansion panel may include flow disrupters, for example in the form of fins, to assist with heat transfer between the battery cells and the coolant.

In other alternative embodiments, the expansion panel does not include internal mechanical springs, but instead the entire assembly is made higher pressure stable. In this case, the face force would be generated by the internal pressure of either air, or a pumping fluid. In this case, the expansion panel may be considered to be a cooled pressure bladder.

Embodiments of the disclosure have been described above by way of example only, and modification in detail are possible. Features of one embodiment may be used in combination with those of any other embodiment. Other modifications will be apparent to the skilled person within the scope of the claims.

What is claimed is:

1. An expansion panel for installation against a battery cell in a battery assembly, the expansion panel comprising:
two plates, wherein at least one plate is arranged to face the battery cell; and
a spring layer between the two plates.

2. The expansion panel of claim 1, wherein the spring layer is arranged to store elastic potential energy when it is compressed.

3. The expansion panel of claim 1, wherein the expansion panel is arranged to apply a predetermined pressure to the battery cell.

4. The expansion panel of claim 1, wherein the expansion panel is arranged to accommodate expansion and contraction of the battery cell during a charge/discharge cycle.

5. The expansion panel of claim 1, wherein the spring layer comprises a mechanical spring mechanism.

6. The expansion panel of claim 1, wherein the spring layer comprises a corrugated layer of elastic material.

7. The expansion panel of claim 1, wherein the spring layer comprises an array of springs.

8. The expansion panel of claim 1, wherein the spring layer is arranged to apply different pressures to different areas of the battery cell.

9. The expansion panel of claim 1, wherein each plate comprises a sheet of metal.

10. The expansion panel of claim 1, wherein the two plates are at least partially connected to at least partially enclose the spring layer.

11. The expansion panel of claim 10, wherein the spring layer comprises channels which allow a flow of coolant through an interior of the expansion panel.

12. The expansion panel of claim 10, wherein the expansion panel comprises at least one port arranged to supply coolant to an interior of the expansion panel.

13. The expansion panel of claim 1, wherein the expansion panel is arranged to provide a flame barrier between battery cells in the battery assembly.

14. A battery assembly comprising:
a plurality of battery cells; and
at least one expansion panel between two adjacent battery cells, the expansion panel comprising:
two plates, each plate arranged to face a respective battery cell; and
a spring layer between the two plates.

15. The battery assembly of claim 14, wherein the battery assembly is arranged such that coolant can be supplied to an interior of the at least one expansion panel.

16. The battery assembly of claim 14, wherein the battery cells and the at least one expansion panel are immersed in coolant.

17. The battery assembly of claim 16, further comprising a sealed housing, wherein the battery cells, the at least one expansion panel and the coolant are contained in the housing.

18. The battery assembly of claim 14, wherein the at least one expansion panel is open on opposing sides to allow coolant to flow through the expansion panel.

19. A method of assembling a battery assembly, the battery assembly comprising a plurality of battery cells and at least one expansion panel, the expansion panel comprising two plates and a spring layer between the two plates, the method comprising:
stacking the battery cells with an expansion panel between two adjacent battery cells;
compressing the stack of battery cells to compress the spring layer; and
retaining the compressed stack of cells with a support structure.

20. The method according to claim 19, further comprising circulating a coolant through the expansion panel.
